(19) United States
(12) Patent Application Publication
(10) Pub. No.: US 2014/0084086 A1
(43) Pub. Date: Mar. 27, 2014

(54) INTEGRATED PISTOL GRIP WATER SPRAYER

(71) Applicant: Global Link Sourcing, Inc., Murrieta, CA (US)

(72) Inventors: Travis Lee Pellerin, Winchester, CA (US); Joshua Paul Goldfarb, Huntington Beach, CA (US)

(21) Appl. No.: 14/034,523

(22) Filed: Sep. 23, 2013

Related U.S. Application Data
(60) Provisional application No. 61/704,719, filed on Sep. 24, 2012.

(51) Int. Cl. B05B 12/00

(52) U.S. Cl. CPC B05B 12/002
USPC 239/526

(57) ABSTRACT

A water sprayer is described. The water sprayer includes: a body having a flow pathway comprising a tapered fluid passage and a flow control element; an input port coupled to an input of the flow pathway, the input port adapted to receive a supply of water; and a flow control lever coupled to the flow control element, the flow control lever adapted to at least partly control the flow of water through the flow pathway. A fluid delivery device includes: an input port able to be connected to a fluid supply; an entry chamber coupled to the input port; a control feature cavity coupled to the entry chamber; and a tapered fluid passage coupled to the control feature cavity. An extendable water sprayer includes: an input port; a flow pathway; an output port; and an extension handle receptacle.

### CROSS-REFERENCE TO RELATED APPLICATIONS

This application claims priority to U.S. Provisional Patent Application Ser. No. 61/704,719, filed on Sep. 24, 2012.

### BACKGROUND OF THE INVENTION

Many people may utilize devices such as power washers to generate a high-pressure flow of water that may be used to generate a stream of water for use in cleaning (e.g., washing cars, boats, etc.) and/or other purposes. Such devices require connection of a pressurized water supply and a power supply (e.g., an electric connection to an AC power source, gas powered engine, etc.) in order to operate. These devices may typically include a sprayer attachment, dedicated hose, and a heavy base unit that must be moved within a workable distance to an appropriate power supply and the item to be washed.

In addition, existing power washers may include various elements that are inconvenient to store, transport, and setup (e.g., a base unit may be heavy and large, various sprayer attachments may be relatively large and oddly shaped, a dedicated hose may be required, etc.).

Furthermore, existing sprayers may not be adapted to allow for extending the reach of the sprayer by connecting the sprayer to readily available standard poles or rods.

Therefore there exists a need for a self-contained, easily transportable, small, lightweight, durable, high-pressure, controllable flow water sprayer that allows for extended reach and does not require any inputs or power supply other than a standard pressurized water supply and a typical garden hose.

### BRIEF SUMMARY OF THE INVENTION

Some embodiments of the invention may provide a water (and/or other appropriate fluids) sprayer that is adapted to produce a high-pressure output without using a motor or other powered source (other than water pressure supplied by a typical outdoor home or building water spigot or faucet and garden hose, for example).

The water sprayer may be adapted to accept a variety of extension handles such that the reach of the sprayer may include the length of the supply hose(s) and/or the extension handle used. The water sprayer may include a female thread in the base of a handle with a pistol grip configuration. Such a female thread may couple to a male threaded end of an extension handle. The extension handles may include, for example, standard broomstick type handles, a painter's extension pole, and/or other standard industrial or home hardware threaded extension poles.

The water sprayer may include a pistol grip portion that is sized to fit inside the end of, for example, a standard pool cleaning telescopic extension pole and is equipped with a standard spring clip that may fit the two opposing apertures of the pole.

The water sprayer may be adapted to allow delivery of water spray pressure directly where desired without suffering a loss of power or velocity by requiring the water stream to travel extended distances from the nozzle to a desired point of impact.

The small size and light weight of the sprayer may make it ideal for storage and the sprayer may easily fit into places and containers that other pressure washers may not (e.g., a toolbox, a five gallon bucket, etc.).

Some embodiments may include a nozzle end that has a male thread that may allow different nozzles to be threaded onto (and/or otherwise appropriately connected). The nozzle end may have a small diameter (e.g., less than one inch), and being narrow can thus be inserted into small spaces for cleaning out crevices or other areas with small openings.

Some embodiments may include an adjustable flow ball valve that is able to be manipulated by a side-mounted lever that rotates the ball valve in such a way as to control the flow of water from an attached garden hose (or other supply) out through the nozzle. The nozzle end may be adapted to accept a variety of thread-on nozzles, each adapted to perform different functions. Some nozzles may include bristles, foam pads, and/or other appropriate cleaning elements that may allow water to flow through the element(s).

Some embodiments may include a laterally tapered elongated barrel that water passes through before reaching the nozzle end. This barrel may act to increase the pressure of the water flow through the sprayer.

Some embodiments may include an adjustable angle adaptor (such as a hinge and/or other movable element such as a ball-and-socket connector) between the extension handle and the water sprayer. The adjustable adaptor may be built into a port for the extension handle.

A first exemplary embodiment of the invention provides a water sprayer. The water sprayer includes: a body having a flow pathway comprising a tapered fluid passage and a flow control element; an input port coupled to an input of the flow pathway, the input port adapted to receive a supply of water; and a flow control lever coupled to the flow control element, the flow control lever adapted to at least partly control the flow of water through the flow pathway.

A second exemplary embodiment of the invention provides a fluid delivery device. The fluid delivery device includes: an input port able to be connected to a fluid supply; an entry chamber coupled to the input port; a control feature cavity coupled to the entry chamber; and a tapered fluid passage coupled to the control feature cavity.

A third exemplary embodiment provides an extendable water sprayer. The extendable water sprayer includes: an input port adapted to be coupled to a water supply; a flow pathway coupled to the input port; an output port coupled to the flow pathway; and an extension handle receptacle coupled to a body housing the input port, flow pathway, and output port.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIG. 1 illustrates a right side view of an integrated pistol grip water sprayer of some embodiments;

FIG. 2 illustrates a perspective view of the integrated pistol grip water sprayer of FIG. 1;

FIG. 3 illustrates a rear view of the integrated pistol grip water sprayer of FIG. 1;

FIG. 4 illustrates a top view of the integrated pistol grip water sprayer of FIG. 1;

FIG. 5 illustrates a left side cross-section view of the integrated pistol grip water sprayer of FIG. 1;

FIG. 6A illustrates a detailed left side view of a water entry and control feature of the integrated pistol grip water sprayer of FIG. 1;

FIG. 6B illustrates an exploded view of a water entry feature of the integrated pistol grip water sprayer of FIG. 1;

FIG. 6C illustrates a cross-section view of the water entry feature of the integrated pistol grip water sprayer of FIG. 1;

FIG. 6D illustrates an exploded front view of a flow control feature of the integrated pistol grip water sprayer of FIG. 1;

FIG. 6E illustrates a side view of a flow control feature of the integrated pistol grip water sprayer of FIG. 1;

FIG. 6F illustrates a cross-section view of a flow control feature of the integrated pistol grip water sprayer of FIG. 1;

FIG. 7 illustrates a left side view and an end view of the integrated pistol grip water sprayer of FIG. 1;

FIG. 8 illustrates a bottom view of a section of the integrated pistol grip water sprayer of FIG. 1;

FIG. 9 illustrates a bottom cross-section view of the section of the integrated pistol grip water sprayer of FIG. 1 shown in FIG. 8;

FIG. 10 illustrates various views of a nozzle that may be attached to the integrated pistol grip water sprayer of FIG. 1; and

FIG. 11 illustrates front views of various nozzles that may be attached to the integrated pistol grip water sprayer of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features. Broadly, embodiments of the present invention generally provide a high-pressure water sprayer.

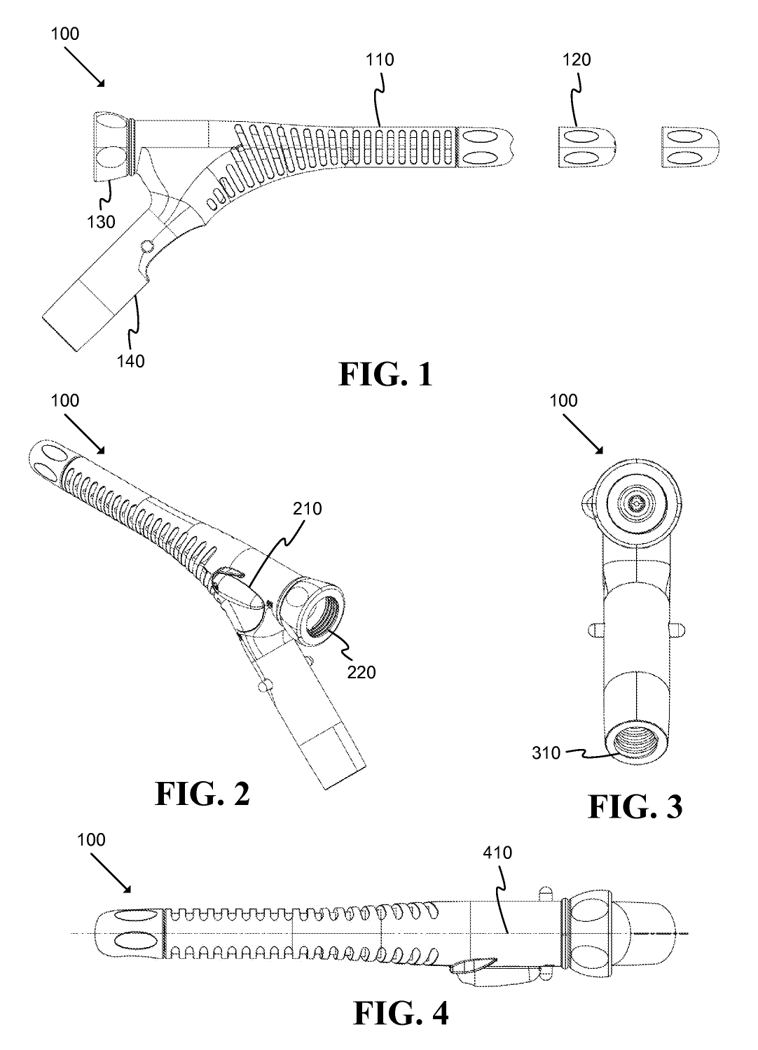

FIG. 1 illustrates a right side view of an integrated pistol grip water sprayer 100 of some embodiments. Specifically, this figure shows various components of the water sprayer 100. Although the sprayer 100 will be described by reference to water, one of ordinary skill in the art will recognize that the sprayer may be used with various different fluids (or combinations of fluids) without departing from the spirit of the invention. As shown, the water sprayer 100 may include a pistol grip body 110, one or more nozzles 120, a hose end knob 130 and an extension handle receptacle 140.

The pistol grip body 110 may be adapted to allow a user to comfortably hold and/or manipulate the sprayer 100 during use. Each nozzle 120 may be adapted to produce a particular type of output. Such outputs may be defined by factors such as spray pattern, volume of water, output pressure, etc. The hose end knob 130 or other appropriate input connector and/or port may be configured to couple the sprayer 100 to a water source (e.g., a hose) and may include a standard garden hose thread, English thread, and/or other appropriate connector(s). The extension handle receptacle 140 may be adapted to connect the sprayer 100 to an extension pole or rod (not shown). The extension handle receptacle 140 may include a standard three quarter inch female thread and/or other appropriate thread for connecting a variety of extension poles and/or rods.

The sprayer 100 may include various different appropriate materials (e.g., plastic, metal, rubber, etc.). In some embodiments, rigid elements of the sprayer (e.g., the body, the nozzle, etc.) may be made from plastic, while various internal and/or external gaskets (not shown) may be made from rubber. The materials used may be chosen based on non-corrosive properties when exposed to water (or other fluid to be sprayed). As shown, the sprayer 100 may be formed such that the outer surface of at least a portion of the body 110 has various cutouts (or through-holes, cavities, etc.) that may allow less material to be used and provide a light weight structure that allows for more ease of use.

FIG. 2 illustrates a perspective view of the integrated pistol grip water sprayer 100. In this view, a flow control lever 210 and threaded connector 220 are visible. The flow control lever 210 may be adapted to allow the flow of water through the sprayer 100 to be controlled. Such flow control may allow a user to adjust the volume of water passing through the sprayer 100 and/or to stop the flow of water through the sprayer. The threaded connector 220 may be adapted to allow a standard garden hose to be attached to the sprayer 100.

FIG. 3 illustrates a rear view of the integrated pistol grip water sprayer 100. In this view, a threaded connector 310 is visible. The connector 310 may allow a complementary threaded pole or rod to be secured to the extension handle receptacle 140. Different embodiments may include various different types of connectors and/or connections (e.g., compression fit, securing clip, etc.).

FIG. 4 illustrates a top view of the integrated pistol grip water sprayer 100. Specifically, this figure shows the path 410 of water flow through the sprayer 100 when in use.

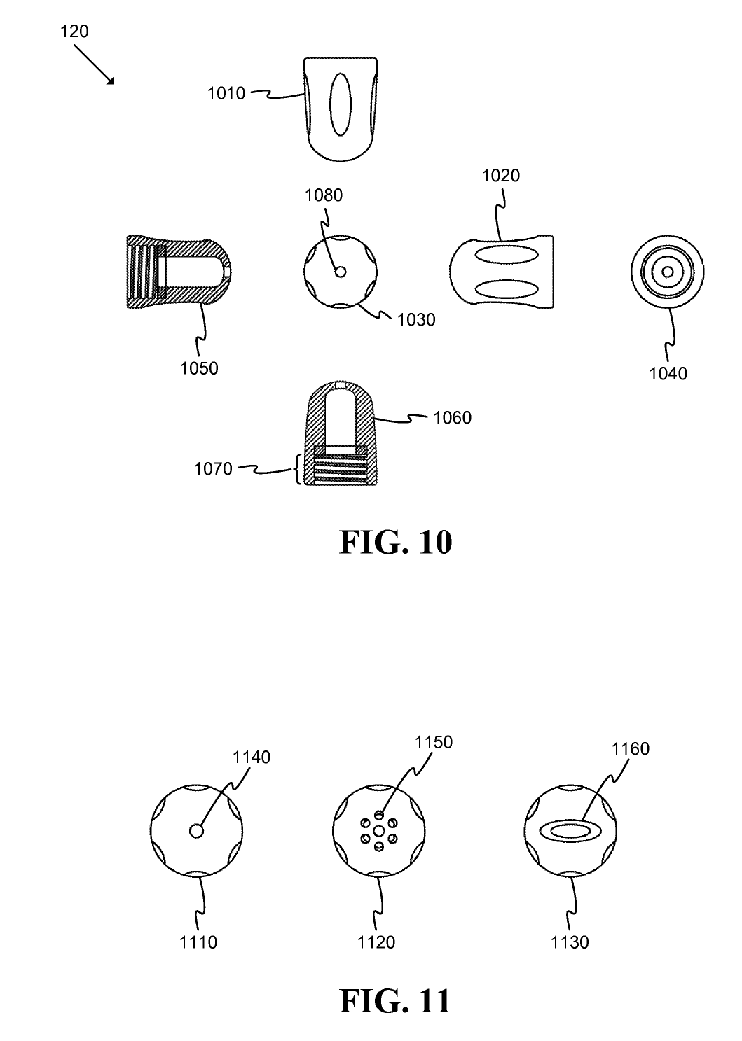

During a typical operation scenario, the sprayer may first be attached to an extension pole or rod via the extension handle receptacle 140, if desired. Next, a nozzle 120 may be connected to the body 110 (e.g., by screwing a nozzle onto a threaded connector of the body). In some embodiments, the sprayer 100 may be used without any attached nozzle. In some embodiments, the nozzle 120 may be permanently connected to the body 110 (e.g., using adhesives) and/or formed as part of the body. The nozzle 120 may have characteristics suiting a specific purpose of the sprayer 100. Nozzles of some embodiments will be described in more detail in reference to FIGS. 10-11 below.

A water supply may then be connected to the hose end knob 130 (e.g., by repeatedly turning the hose end knob to engage a complementary thread on one end of a hose). Next, the water supply may be activated (e.g., by turning a spigot attached to the other end of the hose), the pistol grip body 110 grasped, and the sprayer 100 may be used by pointing the output of the nozzle 120 at the desired location(s) and selecting the desired flow by adjusting the flow control lever 210.

The operations described above may be performed in various different ways, as appropriate. For instance, in some cases a user may have a water supply connected at all times, and use either the flow control lever 210 or an output control of the water supply (e.g., a spigot connected to a hose) to stop the flow of water to the sprayer while the user disconnects a first nozzle 120 and then connect a second nozzle. Likewise, a user may simply wish to connect or disconnect an extension pole during use without changing any other operational parameter (e.g., using the same nozzle, water supply, etc.).

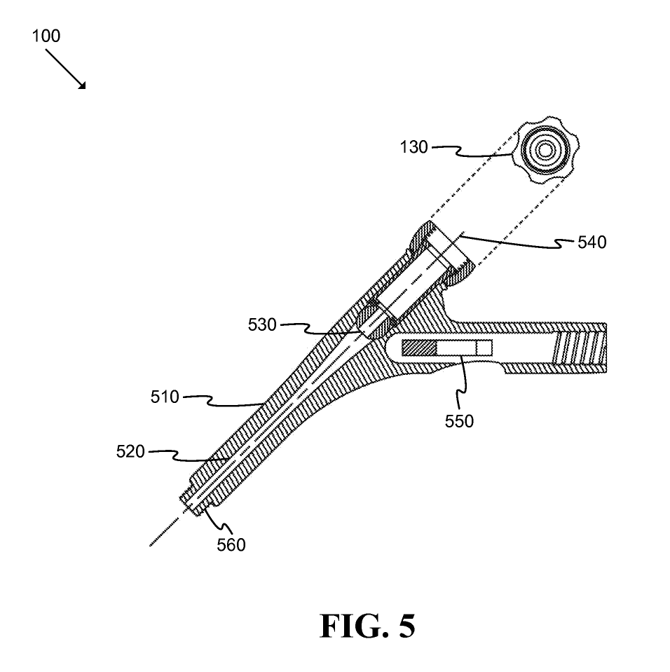

FIG. 5 illustrates a left side cross-section view of the integrated pistol grip water sprayer 100. Specifically, this figure shows the fluid pathway and flow control features of some embodiments. In addition, this figure shows an end view of the hose end knob 130. As shown, the sprayer 100 may include a barrel 510 with a tapered fluid passage 520, a flow control element 530 (e.g., a ball valve) that may be adapted to at least partially control the flow of fluids along the path 540 through the sprayer 100, a securing element 550 (e.g., a spring clip), and a threaded connector 560 (or “nozzle end”).

The tapered passage 520 may be adapted to generate a desired pressure at the outlet of the sprayer 100. The ball valve 530 may be coupled to the flow control lever 210 and may be adapted to control the flow of water through the sprayer 100. In some embodiments, the ball valve 530 may include a shaft that extends partially into the ball (but does not reach the passageway through the valve). The body 110 may include a through-hole that is adapted to allow access to the shaft. In some embodiments, the ball valve 530 may be connected to the flow control lever 210 using a screw that passes through the lever and engages the shaft of the ball valve 530. In addition, a donut-shaped gasket may be compressed between the ball valve, the lever 210, and the through-hole, such that a watertight seal is formed.

In the example of FIG. 5, the ball valve 530 is shown in an “open” position (i.e., a position where water is allowed to flow along path 540) where a hole through the valve is aligned with the path 540. Such a ball valve may be partially or completely rotated along an axis perpendicular to path 540 such that the valve may be partially or completely moved to a “closed” position (i.e., a position where no water is allowed to flow along path 540). The ball valve 530 may be manipulated using lever 210 such that the flow of water may be adjusted from a minimum level (e.g., closed) to a maximum level (e.g., open) and/or set to a level between the minimum and maximum by moving the ball valve 530 such that at least part of the hole through the valve is obstructed. In this way, a user may vary the flow of water through the sprayer 100 as desired.

The spring clip (and/or other appropriate fastening element) 550 may be adapted to secure an extension pole or rod to the extension handle receptacle 140.

The nozzle end 560 may allow a nozzle 120 to be attached to the barrel 510. As shown, the threaded nozzle connector 560 may be located at the output of the sprayer and may be threaded. Alternatively, the nozzle connector may include various compression fittings, seals, gaskets, locking clips, and/or other appropriate connection elements. The nozzle connector may be adapted to secure different nozzles 120 having appropriate complementary connection elements.

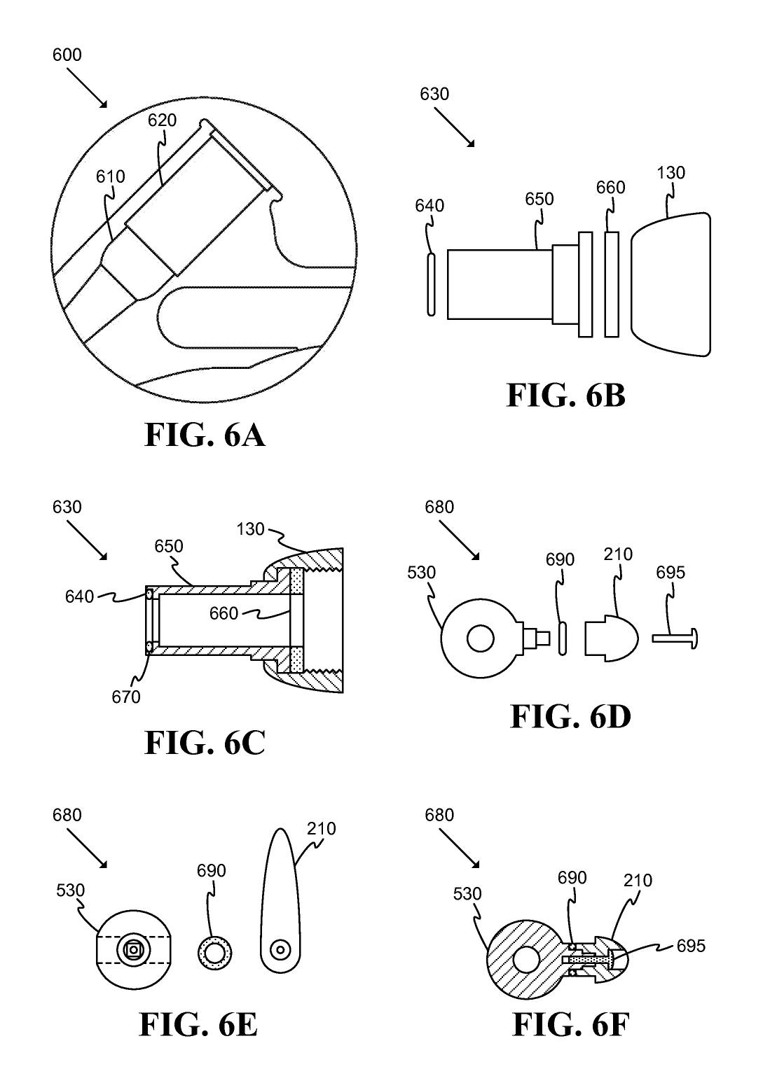

FIG. 6A illustrates a detailed left side view of a water entry and control feature 600 of the integrated pistol grip water sprayer 100. Specifically, this figure shows the water pathway from the hose end knob 130 through the ball valve 530. The feature 600 may include a control feature cavity 610 adapted to house the ball valve 530 and an entry chamber 620 adapted to house coupling and sealing elements of some embodiments. In some embodiments, the control feature cavity 610 may be shaped and sized to accept an appropriate flow control element (e.g., a ball valve) while the entry chamber 620 may be a cavity that is shaped and sized to accept various elements (e.g., a sleeve, gaskets, etc.) that may allow the sprayer 100 to be connected to a water source.

FIG. 6B illustrates an exploded view of a water entry feature 630 of some embodiments. FIG. 6C illustrates a cross-section view of the water entry feature 630 of some embodiments. As shown, the water entry feature may include a gasket 640, a sleeve 650, another gasket 660 and the hose end knob 130. The water entry feature 630 may be sized and shaped to fit within the entry chamber 620.

The gasket 640 may be made of appropriate materials (e.g., rubber) and may have a donut shape that is sized to provide a seal between a ball valve, the control feature cavity 610, and one end of the sleeve 650. The gasket 640 may fit within a recess 670 included in the sleeve 650. The sleeve may be made of appropriate materials (e.g., plastic) and may be generally cylindrically shaped and sized to fit within the entry chamber 620. The other gasket 660 may be made of appropriate materials (e.g., rubber) and be shaped and sized to form a seal between the sleeve 650, the hose end knob 130, and a water source such as a hose. Such seals may be adapted to prevent leakage from the hose or other supply element and/or through the ball valve (when closed) while under compression. In this way, the sprayer 100 may be able to maintain higher pressure through the flow pathway 540.

FIG. 6D illustrates an exploded front view of a flow control feature 680 of some embodiments. FIG. 6E illustrates a side view of a flow control feature 680 of some embodiments. FIG. 6F illustrates a cross-section view of a flow control feature 680 of some embodiments. As shown, the flow control feature may include a ball valve 530, a gasket 690, a lever 210, and a securing element 695 (e.g., a screw, rivet, etc.). The flow control feature 680 may be sized and shaped to fit within the control feature cavity 610. In some embodiments, the sprayer 100 may include a through-hole from the cavity 610 to an exterior surface of the body 110 that may allow the control feature 680 to rotate about the center of the through-hole.

The assembled feature may form a watertight seal between the gasket 680, the valve 530, the lever 210, and the body 110 of the sprayer 100. As shown, in some embodiments, the valve 530 may include a rectangular protuberance that corresponds to a similarly shaped receptacle of the lever 210 (not shown). In this way, when the lever is rotated about the center point of the through-hole, the ball valve 530 will likewise rotate about the center point, causing the passage through the valve to move in relation to the cavity 610 and the tapered passage 520, thus controlling the flow of water through the flow path 540.

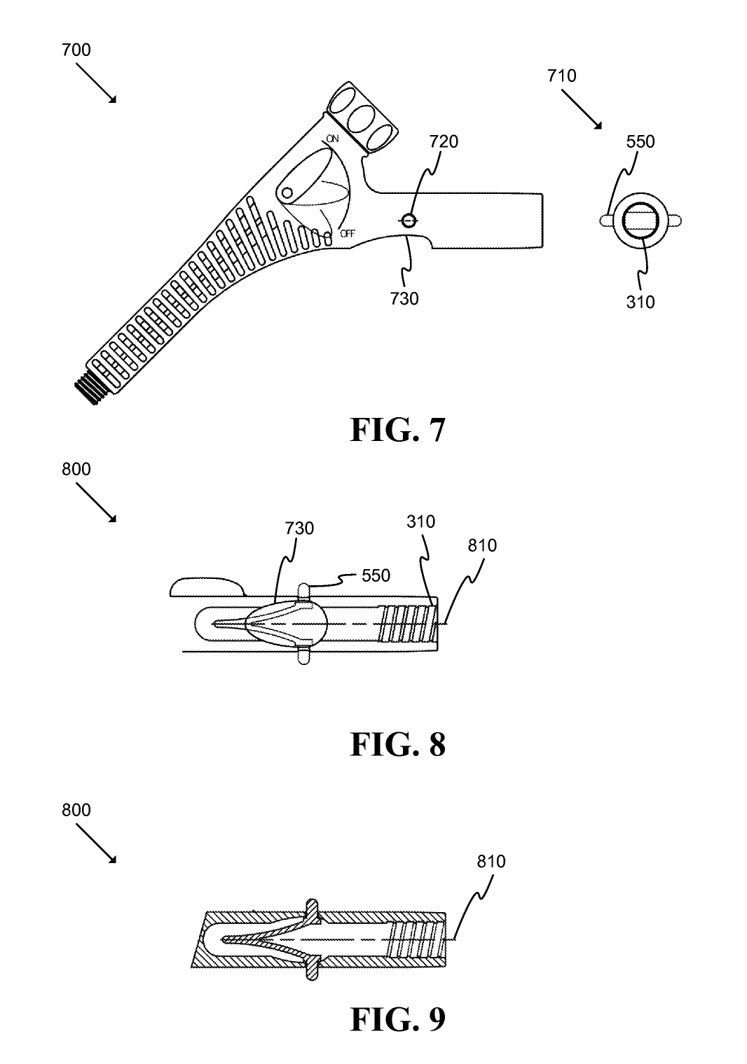

FIG. 7 illustrates a left side view 700 and end view 710 of the integrated pistol grip water sprayer 100. FIG. 8 illustrates a bottom view of a section 800 of the integrated pistol grip water sprayer 100. FIG. 9 illustrates a bottom cross-section view of the section 800 of the integrated pistol grip water sprayer 100. Specifically, these figures show various fasteners and/or connectors that may be provided by the extension handle receptacle 140.

As shown, the extension handle receptacle may have associated retention holes 720, an opening 730, a threaded connector 310 along the inside surface of the extension handle receptacle 140 opening and a spring clip 550. In some cases, the spring clip may be included with the extension rod or pole and would not be part of the sprayer (and/or would be removed from the sprayer prior to use).

Each retention hole 720 may be adapted to receive a protruding end of the spring clip 550. The opening 730 may be adapted to allow the spring clip 550 to be connected to or removed from the extension handle receptacle 140.

The spring clip 550 may be adapted to secure an extension pole or rod in the extension handle receptacle 140 end by passing through corresponding holes in the extension pole or rod, thus preventing the pole or rod from moving along an axis 810 that runs along the center of the shaft extending from the extension handle receptacle 140 opening. The spring clip 550 may be have a wishbone shape and be made from materials (e.g., plastic) such that the clip may be flexible enough to fit into the extension handle receptacle 140 (and/or extension pole) when compressed and rigid enough to secure the pole (via holes 720) when released from compression.

The threaded connector 310 may be adapted to secure an alternative extension pole having a complementary threaded end.

During operation, an extension rod or pole may be secured to the extension handle receptacle 140 by passing the spring clip 550 through the opening 730, inserting the pole into the extension handle receptacle 140 opening, and engaging the ends of the spring clip 550 through the retention holes 720 (e.g., by releasing the ends of the spring clip 550 after the ends have been aligned with the holes) and associated holes in the pole or rod.

Alternatively, the spring clip 550 may be inserted into retention holes on a pole or rod, and the ends compressed toward the center of the pole as the pole and clip are inserted into the extension handle receptacle 140 opening until the ends of the spring clip 550 are engaged in the retention holes 720. Similarly, the extension rod may be removed from the extension handle receptacle 140 by releasing the ends of the spring clip 550 from the retention holes 720 (e.g., by squeezing the ends toward the center of the pole such that the ends are disengaged from the retention holes). A worn out or broken spring clip 550 may thus be pulled out through the opening 730 and/or a new spring clip 550 may be inserted. The clip may be removed when a screw-type rod or pole is used.

FIG. 10 illustrates various views of a nozzle 120 that may be attached to the integrated pistol grip water sprayer 100. In this figure, one example nozzle 120 is shown from a top or bottom view 1010, a side view 1020, a front view 1030, a rear view 1040, a side cross-section view 1050 and a top or bottom cross-section view 1060. The cross-section views 1050-1060 show a threaded connector 1070 that may be included in some embodiments and may be complementary to threaded connector 560. In some embodiments, a gasket or washer (not shown) may be placed between the nozzle 120 and the sprayer body 110 to form a watertight seal such that any water flowing through the sprayer 100 is forced through the nozzle opening 1080.

FIG. 11 illustrates front views of various nozzles 1110-1130 that may be attached to the integrated pistol grip water sprayer 100. Specifically, this figure shows various different output configurations that may be employed by a nozzle of some embodiments. The threaded nozzle connector 560 may be adapted to accept a variety of thread-on nozzles 120, each adapted to perform with different attributes. Alternatively, other appropriate connectors may be used.

As shown, different nozzles may have outlets of varying size, shape, quantity, and/or arrangement. Each outlet configuration may affect the water stream, flow, and/or pressure differently and may allow the nozzles to be suited for different tasks.

As shown, a first exemplary nozzle 1110 may include a single round outlet 1140 of appropriate diameter (e.g., from one-sixteenth of an inch to one quarter of an inch) and may generate a single high pressure stream.

Another exemplary nozzle 1120 may include several round outlets 1150 that are spaced about and within a circle (or other appropriate shape). This nozzle 1120 may be adapted to generate a wide spray pattern. Some or all of the nozzle outlets may be placed at an angle not directly in line with the barrel of the sprayer. In some embodiments, the outlets 1150 spaced around the center outlet 1140 may be angled away from axis 540 such that the spray pattern is further widened.

Yet another nozzle opening 1130 may be shaped like an elongated ellipse with an outlet that is angled away from axis 540 and may generate a fan spray pattern.

One of ordinary skill in the art will recognize that although the sprayer 100 has been described by reference to various specific details, such a sprayer may be implemented in various different ways without departing from the spirit of the invention. For instance, some embodiments may not include an extension handle receptacle 140 (e.g., some sprayers 100 may be intended for handheld use only). In addition, the sprayer 100 may be shaped and/or sized in various different ways as appropriate for various different uses, users, and/or other appropriate factors (e.g., different size pistol-grip bodies may be offered to allow users to select the size that is most comfortable based on the hand size of the user).

It should be understood, of course, that the foregoing relates to illustrative details of exemplary embodiments of the invention and that modifications may be made without departing from the spirit and scope of the invention as defined by the following claims.

We claim:

1. A water sprayer comprising:
a body having a flow pathway comprising a tapered fluid passage and a flow control element;
an input port coupled to an input of the flow pathway, the input port adapted to receive a supply of water; and
a flow control lever coupled to the flow control element, the flow control lever adapted to at least partly control the flow of water through the flow pathway.

2. The water sprayer of claim 1 further comprising an extension handle receptacle coupled to the body, the extension handle receptacle adapted to receive an extension pole.

3. The water sprayer of claim 1, wherein the flow control element is a ball valve.

4. The water sprayer of claim 1 further comprising a nozzle end coupled to an output port of the flow pathway, wherein the nozzle end is adapted to receive a nozzle.

5. The water sprayer of claim 4, wherein the nozzle is one of a single outlet stream nozzle, a multiple outlet wide spray nozzle, and a fan nozzle.

6. The water sprayer of claim 1, wherein the input port is able to be coupled to a garden hose.

7. The water sprayer of claim 1, wherein the body has a pistol grip shape.

8. A fluid delivery device comprising:
an input port able to be connected to a fluid supply;
an entry chamber coupled to the input port;
a control feature cavity coupled to the entry chamber; and
a tapered fluid passage coupled to the control feature cavity.

9. The fluid delivery device of claim 8, wherein the input port comprises a hose end knob.

10. The fluid delivery device of claim 8, wherein the entry chamber houses a fluid entry feature comprising:
a sleeve coupled to the hose end knob;
a first gasket located between the hose end knob and the sleeve; and
a second gasket located between the sleeve and the control feature cavity.

11. The fluid delivery device of claim 8, wherein the control feature cavity houses a flow control feature comprising:
a ball valve;
a lever coupled to the ball valve; and
a gasket located between the ball valve and the lever.

12. The fluid delivery device of claim 8 further comprising a threaded nozzle end adapted to couple to at least one nozzle from a set of available nozzles.

13. The fluid delivery device of claim 12, wherein the set of available nozzles comprises a single outlet stream nozzle, a multiple outlet wide spray nozzle, and a fan nozzle.

14. The fluid delivery device of claim 8 further comprising an extension handle receptacle adapted to accept an extension pole.

15. An extendable water sprayer comprising:
an input port adapted to be coupled to a water supply;
a flow pathway coupled to the input port;
an output port coupled to the flow pathway; and
an extension handle receptacle coupled to a body housing the input port, flow pathway, and output port.

16. The extendable water sprayer of claim 15, wherein the input port comprises a threaded hose end knob.

17. The extendable water sprayer of claim 15, wherein the flow pathway comprises a flow control valve and a tapered passage.

18. The extendable water sprayer of claim 15, wherein the output port comprises a threaded nozzle end.

19. The extendable water sprayer of claim 15, wherein the extension handle receptacle comprises a threaded connector.

20. The extendable water sprayer of claim 15, wherein the extension handle receptacle comprises a set of through-holes adapted to receive a spring clip.
